(19) United States
(12) Patent Application Publication
(10) Pub. No.: US 2024/0394123 A1
(43) Pub. Date: Nov. 28, 2024

(54) APPLICATION PORTAL

(71) Applicant: Bank of America Corporation, Charlotte, NC (US)

(72) Inventors: Jennifer Sanctis, Charlotte, NC (US); Mary Bangs, New York, NY (US); Veronica Andrea Cadavid, New York, NY (US); Taylor Farris, Hoboken, NJ (US); Trish Gillis, Chicago, IL (US); Jesse James Godley, Charlotte, NC (US); Brian Meyers, New York, NY (US); Vishwas Korde, Matthews, NC (US)

(21) Appl. No.: 18/200,881

(22) Filed: May 23, 2023

(51) Int. Cl. G06F 9/54; G06F 16/2455

(52) U.S. Cl. CPC G06F 9/546; G06F 16/24568

(57) ABSTRACT

A system is provided for dynamic, secure, real-time, symmetrical data streaming using an application portal. The system may include a receiver and router, a plurality of short-term servers, a mid-term database, a K-nearest neighbor number identifier, and an application portal. The receiver and router, via the application portal, may receive a request to stream a data element from a source location to an end location. The receiver and router may retrieve the requested data element from one of the short-term servers, the mid-term database, and/or the source location. Once the data element is retrieved, the data element may be indexed by the K-nearest neighbor number identifier. The application portal may tag the data element with an application number. Based on the application number, a short-term server may be selected. The data element may be forwarded to the selected short-term servers. The short-term storage, via the application portal, may stream the data element to the end location.

### FIELD OF TECHNOLOGY

Aspects of this disclosure relate to an application portal for data streaming.

### BACKGROUND OF THE DISCLOSURE

Data streaming environments involve receiving streams of large quantities of data elements at data file systems or database file systems. Examples of data file systems or database file systems may include Hadoop®, Kafka®, Oracle®, etc.

There exist challenges in data streaming environments. One set of challenges may occur during real-time streaming of the data elements. The receiving system may not be able to control which data elements arrive at the system, when the data elements arrive at the system, the order in which the data elements arrive at the system, and the format in which the data element arrive at the system.

Another challenge may be the size of the data element being streamed as compared to the size of the streaming system. For example, the size of the data requested for streaming may be too large for the streaming system or streaming location to handle.

Yet another challenge may be the order in which the data arrives. The order of the data elements may be haphazard or erratic. For example, a January 10th file may arrive first, while January 1st file may arrive second.

Still another challenge may include the format in which the data arrives. The system may not be informed of the format in which the data will arrive, and the data may be received in various formats.

And another challenge may include a need for use of multiple applications simultaneously to perform certain actions. Using multiple applications is clunky and requires downloading and installing each application. Further, each application may require separate authentications with separate authentication requirements.

Therefore, it would be desirable to create an intelligent application portal platform that manages large data streaming requests. It would be preferable for the intelligent application portal platform to receive the requests, retrieve the indicated data, store the data in an organized manner, and forward the data to the requestor.

It would be further desirable to utilize an application portal to stream large applications from a streaming location without the need to download the large applications.

### SUMMARY OF THE DISCLOSURE

Apparatus and methods for dynamic, secure, real-time symmetrical data streaming leveraging an application portal are provided.

An application portal connects with one or more applications. The application portal bridges separate applications, and streams their data, without requiring a user to download the applications individually.

A requestor may transmit a request to stream a data element. A data element may be a de minimis amount of data. A data element may be a qubit of data. A data element may be more than a de minimis amount of data. A data element may be an application. A data element may be a data stream. A data element may be digital, audio, visual, and/or written data. A data element may be any form of data.

The request may be received at a streaming location. The request may include details of the data element. The request may include metadata relating to the data element. The metadata may include a source location. The source location may be a memory location from where the data can be retrieved.

Methods may include identifying whether the requested data is available within the streaming location. When the requested data is available within the streaming location, methods may include streaming the data from the streaming location to a location specified by the requestor.

When the requested data element is not available within the streaming location, the data element may be streamed from a source location to the streaming location. The details of the source location may be identified within the metadata of the data element. The source location may be a different location from the streaming location.

The data element may be forwarded to an identification and routing location within the streaming location. A copy of the data element may be forwarded from the identification and routing location to a schema-agnostic, horizontally-scalable database for storage. The database may be located within the streaming location. The database may be a NoSQL (No Structured Query Language) database.

There may be a container that communicates between the identification and routing location and the database. The container may store a set of identifying details relating to the data element.

Concurrent to the forwarding the copy of the data element from the identification and routing location to the database, the data element may also be forwarded to a K-nearest neighbor (“KNN”) calculation location. The KNN calculation location may be located within the streaming location.

The KNN calculation location may determine a K-value for the data element. The K-value may identify the data element. The K-value may be maintained at a K-value history component.

Upon determination of the K-value for the data element, the data element may be forwarded to an application number generation location. The application number generation location may be located within the streaming location.

An application number generation algorithm may be executed on the data element at the application number generation location. The algorithm may generate an application number. The application number may uniquely identify the data element with respect to other data elements stored in a group of applications.

The data element and the application number may be forwarded to a data distribution location. The data distribution location may be located within the streaming location. At the data distribution location, an application that is compatible with the data element may be identified and/or selected. The application may be included in a group of applications.

In one embodiment, an application portal enables a user to download, install, and authenticate one or more applications in one application portal. Once authenticated, the one or more applications may list or display links to one or more additional applications on a device screen.

In another embodiment, a user may select one or more of the additional applications. Once selected, the application portal may allow the user to interact with the selected one or more applications, without downloading or installing the selected one or more applications. Interaction may occur similarly to remote access and login to a desktop computer from a distant computer.

In another embodiment, a user may utilize 5G and faster speeds to transmit and receive requested streaming data.

In another embodiment, an application portal acts as a remote desktop login application and may provide a user the illusion of using one or more selected applications in full. For example, a user may not be aware of the streaming of code or data from the cloud because of a seamless experience.

In another embodiment, an application portal may utilize dynamic data. Dynamic data may allow the application portal to stream the various applications instead of downloading and installing each application, reducing storage requirements and application clutter.

In another embodiment, an application portal may connect to a server or other computer and open one or more applications on the server or other computer, acting as a remote desktop type application.

In another embodiment, an application portal acts as a portal to one or more applications, without downloading and installing those other applications.

In another embodiment, an application portal uses dynamic data to stream code and other data from a server to a smart device, without installing the application.

In another embodiment, an application portal acts as a remote desktop login application, creating the illusion a user is using the linked application on their mobile device, while streaming or hosting the linked application on a cloud or elsewhere.

In one embodiment, the server may be selected based on an application number associated with the data element. Each server included in the group of servers may be associated with a subrange of numbers included in a predetermined range of numbers. The application number may be selected from the predetermined range of numbers. The data distribution location may determine in which subrange of numbers the application number is included. The data distribution location may then select the server that is associated with the subrange of numbers that includes the application number. Because data elements are distributed based on a generated application number, and a new application number may be generated for each data element, the data distribution location may distribute received data elements evenly to the group of servers.

The data distribution location may forward the data element and the application number to the identified server. The data element may be received at the identified server. The data element may be streamed from the identified server to the requestor and/or a location specified by the requestor.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows an illustrative diagram in accordance with principles of the disclosure;

FIG. 2 shows another illustrative diagram in accordance with principles of the disclosure;

FIG. 3 shows yet another illustrative diagram in accordance with principles of the disclosure;

FIG. 4 shows still another illustrative diagram in accordance with principles of the disclosure;

FIG. 5 shows yet another illustrative diagram in accordance with principles of the disclosure;

FIG. 6 shows still another illustrative diagram in accordance with principles of the disclosure;

FIG. 7 shows an illustrative flow chart in accordance with principles of the disclosure; and

FIG. 8 shows another illustrative flow chart in accordance with principles of the disclosure.

### DETAILED DESCRIPTION OF THE DISCLOSURE

Apparatus, systems, and methods for dynamic, secure, real-time, symmetrical data streaming leveraging an application portal is provided.

The system may include an initial identifier and router. The initial identifier and router may receive one or more data streaming requests. The one or more data streaming requests may be received from a plurality of users. The initial identifier and router may execute the one or more data streaming requests. The execution of the one or more data streaming requests may include retrieval of one or more data elements, included in the one or more data streaming requests, from one or more source locations.

The initial identifier and router may also forward a plurality of streamed data elements, identified in the one or more data streaming requests, to one or more storage locations for future retrieval.

The system may also include a mid-term storage database. The mid-term storage database may store a copy of the streamed data elements for a first predetermined time period. The first predetermined time period may be twenty-four hours, thirty-six hours, seventy-two hours, one week, one month or any other suitable time period. It should be noted that the time period may limit the amount of data elements stored in the mid-term storage database. Because the mid-term storage database may not be intended to replicate a long-term storage location, after the predetermined time period has lapsed, the data element may be deleted from the mid-term storage database.

The system may also include a first communication element. The first communication element communicates between the mid-term storage database and the initial identifier and router. The first communication element may maintain an index of the copy of the streamed data elements stored in the mid-term storage database.

The system may also include a K-nearest neighbor number identification component. The K-nearest neighbor number identification component may receive the streamed data elements from the initial identifier and router. The K-nearest neighbor number identification component may also identify a K-value for each streamed data element.

K-nearest neighbor number identification, also referred to as KNN, may be an artificial intelligence algorithm for identifying an unknown data element. The premise of the algorithm may include identifying data points that are similar to the unknown data element. The unknown data point is classified based on similar known data points or known neighbors. After identifying a circle of data points, the unknown data element is classified according to the majority of the data points included in the circle of data points.

It is to be noted that, an important element in a KNN calculation is the determination of the size of the circle of neighbors. Depending on the size of the circle, various classified data points may be captured and therefore may influence, or change, the classification of the unknown data point. The size of the circle may be identified as the K-value. A K-value may be the length from the unknown data point to other data points.

In date time values, a K-value may be a month or year, depending on the entry. As such, an unknown entry, or data point, may be identified as part of a January group because the entry is most similar to January entries. In some embodiments, the K-value, such as the January title may be appended to the entry, or data point, being classified.

The system may also include a second communication element. The second communication element communicates between the K-nearest neighbor number identification component and the initial identifier and router. The second communication element may maintain a second index of the streamed data elements included in a group of servers. The index may be based on the K-value.

The system may also include an application number generation component. The application number generation component may receive the streamed data elements from the K-nearest neighbor number identification component.

The system may also include an application number generation component. The application number generation component may generate an application number for each data element included in the plurality of streamed data elements. The application number generation component may tag each data element with the generated application number. The application number generation component may forward each of the plurality of streamed data elements, tagged with the application number, to a data distribution processor.

The data distribution processor may distribute the streamed data elements to a short-term storage server. The short-term storage server may be included in a group of servers. The short-term storage server may store the streamed data elements for a second predetermined time period. The short-term server may stream the data element to the plurality of users.

In some embodiments, the first predetermined time period may be longer than the second predetermined time period. In an exemplary embodiment, the first predetermined time period may be twenty-four hours while the second predetermined time period may be twenty minutes.

The mid-term storage database may delete the copy of the streamed data elements after a lapse of the first predetermined time period. The short-term server may delete the stored streamed data elements after a lapse of the second predetermined time period.

In some embodiments, prior to the execution of the one or more data streaming requests, the initial identifier and router may identify that the short-term storage server includes a requested data element, identified in the one or more streaming requests. The identification may be via the second communication element. The initial identifier and router may stream the requested data element from the short-term storage server to one of the plurality of users.

In certain embodiments, prior to the execution of the one or more data streaming requests, the initial identifier and router may identify that the short-term storage server does not include a requested data element identified in the one or more data streaming requests. The identification may be via the second communication element. The initial identifier and router may identify that the requested data element is included in the mid-term storage database. The identification may be via the first communication element.

Upon identification that the requested data element is included in the mid-term storage database, the initial identifier and router may retrieve the requested data element from the mid-term storage database. The initial identifier and router may forward the requested data element to the K-nearest neighbor number identification component.

The K-nearest neighbor number identification component may identify a K-value for the requested data element. The application number generation component may receive the requested data element from the K-nearest neighbor number identification component. The application number generation component may receive the requested data element from the K-nearest neighbor number identification component. The application number generation component may generate a second application number for the requested data element. The application number generation component may tag the requested data element with the second application number. The application number generation component may forward the requested data element, tagged with the second application number, to the data distribution processor.

The data distribution processor may distribute the requested data element to the short-term storage server included in the group of servers. The short-term storage server may be selected from the group of servers based on the second application number. The short-term storage server may store the requested data element for a third-predetermined time period. The third predetermined time period may be twenty minutes, or any other suitable time period. The short-term storage server may also stream the requested data element to one or more users or requestors.

The data distribution processor may distribute each data element, included in the plurality of streamed data elements, to a server included in the group of servers. One or more data elements may be assigned to the short-term server. The distribution may be based on the generated application number. The short-term storage server may be assigned a predetermined range of numbers and the application number may be included within the predetermined range of numbers.

In one embodiment, a method is provided for dynamic, secure, real-time symmetrical data streaming using an application portal. Symmetrical data streaming is a type of data streaming where the data is processed the same way, regardless of the order it arrives. This contrasts with asymmetrical data streaming, where the data is processed differently, depending on the order it arrives.

In one embodiment, a method is provided for receiving a request from a requestor to stream a data element at a streaming location, and the request is received at that streaming location. A data element may be any quantum of data.

In one embodiment, a method is provided for identifying whether a data element requested is available within a streaming location.

In one embodiment, a method is provided for streaming the data element from a source location to the streaming location, in response to a request, using a source location that is different from the streaming location.

In one embodiment, a method is provided for forwarding the data element to an identification and routing location within the streaming location, which is located at the streaming location.

In one embodiment, a method is provided for forwarding the data element from the identification and routing location to a schema-agnostic, horizontally-scalable database for storage, where the database is located within the streaming location. A schema-agnostic, horizontally-scalable database is a database that does not require a schema and can be scaled horizontally by adding more nodes. Horizontal scalability is the ability to scale a database by adding more nodes. This contrasts with vertical scalability, which is the ability to scale a database by increasing the capacity of the existing nodes.

In one embodiment, a method is provided for storing a set of identifying details relating to the data element at a container that communicates between the identification and routing location and the database.

In one embodiment, a method is provided for forwarding a data element to a K-nearest neighbor (“KNN”) calculation location, where the KNN calculation location is located within a streaming location, and concurrently forwarding a data element from an identification and routing location to a database for storage.

In one embodiment, a method is provided for determining a K-value for the data element at the KNN calculation location, the K-value identifying the data element.

In one embodiment, a method is provided for maintaining the K-value at a K-value history component.

In one embodiment, a method is provided for forwarding the data element to an application portal location, upon determining the K-value for the data element, where the application portal location is located within the streaming location.

In one embodiment, a method is provided for executing, at the application portal location, an application number generation algorithm on the data element, where the algorithm generating an application number, which uniquely identifies a data element with respect to other data elements stored in an application.

In one embodiment, a method is provided for forwarding a copy of the data element and the application number to a data distribution location, said data distribution location located within the streaming location.

In one embodiment, a method is provided for identifying an application, within a group of applications, that is compatible with the data element.

In one embodiment, a method is provided for forwarding the data element and the application number from the data distribution location to the identified application.

In one embodiment, a method is provided for streaming the data element from identified application to the requestor.

In one embodiment, a method is provided for storing the data element at the identified application for a first predetermined time period, said first predetermined time period starting from when the data element is received at the identified application.

In one embodiment, a method is provided for storing the data element at KNN calculation location for a second predetermined time period, said second predetermined time period starting from when the data element is received at the KNN calculation location.

In one embodiment, a method is provided for receiving from a second requestor, a second request at the streaming location, the request received at the streaming location, the request requesting streaming of the data element; identifying, via the K-value history component, that the requested data element is available at the application.

In one embodiment, a method is provided for streaming the requested data element from the application to the second requestor.

In one embodiment, a method is provided for storing the data element at the identified application for a first predetermined time period, said first predetermined time period starting from when the data element is received at the identified application.

In one embodiment, a method is provided for storing the data element at the KNN calculation location for a second predetermined time period, said second predetermined time period starting from when the data element is received at the KNN calculation location.

In one embodiment, a method is provided for receiving from a second requestor, a second request at the streaming location, the request received at the streaming location, the request requesting streaming of the data element.

In one embodiment, a method is provided for identifying, via the K-value history component, that the requested data element is available not available within the group of servers.

In one embodiment, a method is provided for identifying, via the container, that the requested data element is available at the database.

In one embodiment, a method is provided for extracting the data element from the database to the KNN calculation location.

In one embodiment, a method is provided for determining a K-value for the data element at the KNN calculation location.

In one embodiment, a method is provided for maintaining the K-value at the K-value history component.

In one embodiment, a method is provided for determining the K-value for a data element, and forwarding the data element to an application number generation location.

In one embodiment, a method is provided for executing, at the application portal generation location, the application number generation algorithm on the data element, said algorithm generating a second application number, the second application number that uniquely identifies the data element with respect to the other data elements stored in the application.

In one embodiment, a method is provided for forwarding the data element and the second application number to a data distribution location, said data distribution location located within the streaming location.

In one embodiment, a method is provided for identifying a second application, within the group of applications, that is scheduled to receive the data element.

In one embodiment, a method is provided for forwarding the data element and the second application number from the data distribution location to the second application.

In one embodiment, a method is provided for streaming the data element from the second application to the second requestor.

In one embodiment, a method is provided wherein the first predetermined time period is twenty minutes.

In one embodiment, a method is provided wherein the second predetermined time period is twenty-four hours.

In one embodiment, a method is provided wherein the schema-agnostic, horizontally-scalable database is a NoSQL database.

In one embodiment, a method is provided wherein the distribution of received data elements between the group of servers is an even distribution.

In one embodiment, a method is provided wherein the streaming location has an application data size capacity that is less than or equal to a predetermined application data size capacity.

In one embodiment, a method is provided wherein the application has an application data size greater than or equal to a predetermined application data size capacity.

In one embodiment, a system is provided for dynamic, secure, real-time, symmetrical data streaming leveraging an application portal.

In one embodiment, the system has at least an initial identifier and router operable to receive one or more data streaming requests from a plurality of users.

In one embodiment, the system has at least an initial identifier and router operable to execute one or more data streaming requests.

In one embodiment, the system has at least an initial identifier and router operable to forward a plurality of streamed data elements, identified in the one or more data streaming requests, to one or more storage locations for future retrieval.

In one embodiment, the system has a mid-term storage database operable to store a copy of the streamed data elements for a first predetermined time period.

In one embodiment, the system has a first communication element that communicates between the mid-term storage database and the initial identifier and router, and is operable to maintain an index of the copy of the streamed data elements stored in the mid-term storage database.

In one embodiment, the system has a k-nearest neighbor number identification component and is operable to receive the streamed data elements from the initial identifier and router.

In one embodiment, the system identifies a K-value for each streamed data element.

In one embodiment, the system has a second communication element that communicates between the k-nearest neighbor number identification component and the initial identifier and router and is operable to maintain a second index of the streamed data elements included in a group of servers, the second index being based on the K-value.

In one embodiment, the system has an application number generation component, operable to receive the streamed data elements from the k-nearest neighbor number identification component.

In one embodiment, the system has an application number generation component, operable to generate an application number for each data element included in the plurality of streamed data elements.

In one embodiment, the system tags each data element with the application number.

In one embodiment, the system forwards each of the plurality of streamed data elements tagged with the application number to a data distribution processor.

In one embodiment, the system has a data distribution processor operable to distribute the streamed data elements to a short-term storage server included in the group of servers.

In one embodiment, the system has a short-term storage server operable to store the streamed data elements for a second predetermined time period.

In one embodiment, the system streams data elements to a plurality of users.

In one embodiment, the system is provided wherein the first predetermined time period is longer than the second predetermined time period.

In one embodiment, the system is provided wherein the first predetermined time period is twenty-four hours.

In one embodiment, the system is provided wherein the second predetermined time period is twenty minutes.

In one embodiment, the system is provided wherein the mid-term storage database deletes the copy of the streamed data elements after a lapse of the first predetermined time period.

In one embodiment, the system is provided wherein the short-term storage server deletes the stored streamed data elements after a lapse of the second predetermined time period.

In one embodiment, the system is provided wherein the execution of the one or more data streaming requests includes retrieval of one or more data elements, included in the one or more data streaming requests, from one or more source locations.

In one embodiment, the system is provided wherein, prior to the execution of the one or more data streaming requests, the initial identifier and router:

In one embodiment, the system identifies, via the second communication element, that a requested data element, identified in the one or more data streaming requests, is included in the short-term storage server.

In one embodiment, the system streams the requested data element, from the short-term storage server, to one of the plurality of users.

In one embodiment, the system is provided wherein, prior to the execution of the one or more data streaming requests, the initial identifier and router.

In one embodiment, the system identifies, via the second communication element, that a requested data element, identified in the one or more data streaming requests, is not included in the short-term storage server.

In one embodiment, the system identifies, via the first communication element, that the requested data element is included in the mid-term storage database.

In one embodiment, the system retrieves the requested data element from the mid-term storage database.

In one embodiment, the system forwards the requested data element to the k-nearest neighbor number identification component.

In one embodiment, the system is provided wherein the K-nearest neighbor number identification component identifies a K-value for the requested data element.

In one embodiment, the system has an application number generation component, which receives a requested data element from a K-nearest neighbor number identification component.

In one embodiment, the system has an application number generation component, which generates a second application number for the requested data element.

In one embodiment, the system tags the requested data element with the second application number.

In one embodiment, the system forwards the requested data element tagged with the second application number to the data distribution processor.

In one embodiment, the system has a data distribution processor that distributes a requested data element to a short-term storage server, included in the group of servers, and selected from a group of servers based on a second application number.

In one embodiment, the system has a short-term storage server operable to store the requested data element for a third predetermined time period.

In one embodiment, the system streams the requested data element to one or more users.

In one embodiment, the system is provided wherein the data distribution processor distributes each data element, included in the plurality of streamed data elements, to the short-term storage server based on the generated application number, where the short-term storage server is assigned a predetermined range of numbers and the application number is included within the predetermined range of numbers.

In one embodiment, the system is provided wherein the data distribution processor distributes each data element, included in the plurality of streamed data elements, to the short-term storage server and one or more servers included in the group of servers based on each generated application numbers, where each of the group of servers is assigned a predetermined range of numbers and the application number is included within the predetermined range of numbers.

Apparatus and methods described herein are illustrative. Apparatus and methods in accordance with this disclosure will now be described in connection with the figures, which form a part hereof. The figures show illustrative features of apparatus and method steps in accordance with the principles of this disclosure. It is to be understood that other embodiments may be utilized, and that structural, functional, and procedural modifications may be made without departing from the scope and spirit of the present disclosure.

The steps of methods may be performed in an order other than the order shown or described herein. Embodiments may omit steps shown or described in connection with illustrative methods. Embodiments may include steps that are neither shown nor described in connection with illustrative methods.

Illustrative apparatus and method steps may be combined. For example, an illustrative method may include steps shown in connection with another illustrative method.

Apparatus and methods may omit features shown or described in connection with illustrative apparatus and methods. Embodiments may include features that are neither shown nor described in connection with the illustrative apparatus and methods. Features of illustrative apparatus and methods may be combined. For example, an illustrative embodiment may include features shown in connection with another illustrative embodiment.

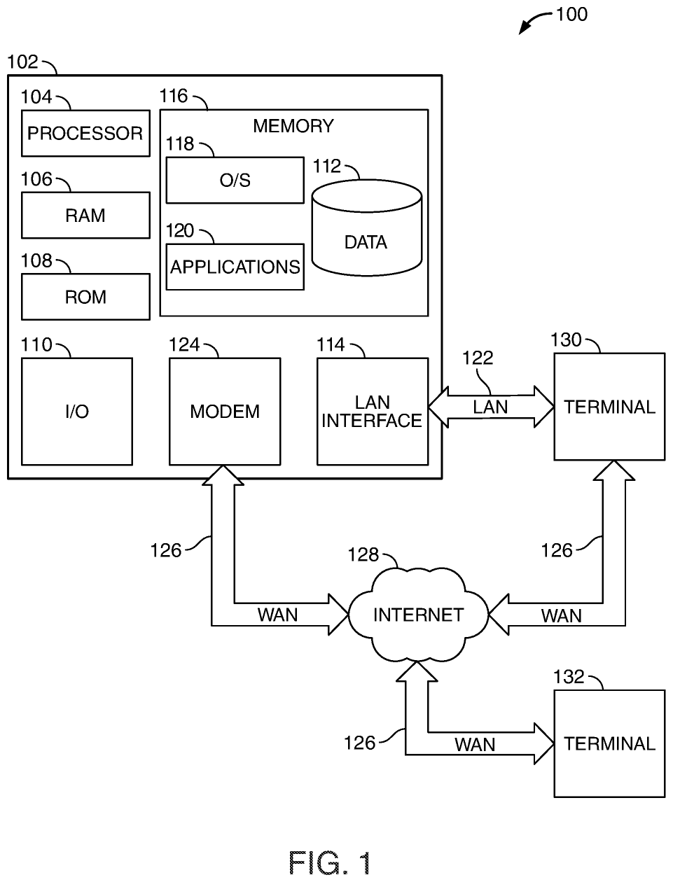

FIG. 1 shows an illustrative block diagram of system 100 that includes computer 102. Computer 102 may alternatively be referred to herein as an “engine,” “server” or a “computing device.” Computer 102 may be a workstation, desktop, laptop, tablet, smartphone, or any other suitable computing device. Elements of system 100, including computer 102, may be used to implement various aspects of the systems and methods disclosed herein.

Computer 102 may have a processor 104 for controlling the operation of the device and its associated components, and may include RAM 106, ROM 108, input/output circuit 110, and a non-transitory or non-volatile memory 116. Machine-readable memory may be configured to store information in machine-readable data structures. The processor 104 may also execute all software running on the computer. Other components commonly used for computers, such as EEPROM or Flash memory or any other suitable components, may also be part of the computer 102.

The memory 116 may be comprised of any suitable permanent storage technology—e.g., a hard drive. The memory 116 may store software including the operating system 118 and application(s) 120 along with any data 112 needed for the operation of the system 100. Memory 116 may also store videos, text, and/or audio assistance files. The data stored in Memory 116 may also be stored in cache memory, or any other suitable memory.

Input/output (“I/O”) module 110 may include connectivity to a microphone, keyboard, touch screen, mouse, and/or stylus through which input may be provided into computer 102. The input may include input relating to cursor movement. The input/output module may also include one or more speakers for providing audio output and a video display device for providing textual, audio, audiovisual, and/or graphical output. The input and output may be related to computer application functionality.

System 100 may be connected to other systems via a local area network (LAN) interface 114. System 100 may operate in a networked environment supporting connections to one or more remote computers, such as terminals 130 and 132. Terminals 130 and 132 may be personal computers or servers that include many or all of the elements described above relative to system 100. The network connections depicted in FIG. 1 include a local area network (LAN) 122 and a wide area network (WAN) 126 but may also include other networks. When used in a LAN networking environment, computer 102 is connected to LAN 122 through a LAN interface 114 or an adapter. When used in a WAN networking environment, computer 102 may include a modem 124 or other means for establishing communications over WAN 126, such as Internet 128.

It will be appreciated that the network connections shown are illustrative and other means of establishing a communications link between computers may be used. The existence of various well-known protocols such as TCP/IP, Ethernet, FTP, HTTP and the like is presumed, and the system can be operated in a client-server configuration to permit retrieval of data from a web-based server or API. Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may be to store the data in cache memory, the hard drive, secondary memory, or any other suitable memory.

Additionally, application program(s) 120, which may be used by computer 102, may include computer executable instructions for invoking functionality related to communication, such as e-mail, Short Message Service (SMS), and voice input and speech recognition applications. Application program(s) 120 (which may be alternatively referred to herein as “plugins,” “applications,” or “apps”) may include computer executable instructions for invoking functionality related to performing various tasks. Application programs 120 may utilize one or more algorithms that process received executable instructions, perform power management routines or other suitable tasks. Application programs 120 may utilize one or more decisioning processes for the processing of calls received from calling sources as detailed herein.

Application program(s) 120 may include computer executable instructions (alternatively referred to as “programs”). The computer executable instructions may be embodied in hardware or firmware (not shown). The computer 102 may execute the instructions embodied by the application program(s) 120 to perform various functions.

Application program(s) 120 may utilize the computer-executable instructions executed by a processor. Generally, programs include routines, programs, objects, components, data structures, etc. that perform particular tasks or implement particular abstract data types. A computing system may be operational with distributed computing environments where tasks are performed by remote processing devices that are linked through a communications network. In a distributed computing environment, a program may be located in both local and remote computer storage media including memory storage devices. Computing systems may rely on a network of remote servers hosted on the Internet to store, manage, and process data (e.g., “cloud computing” and/or “fog computing”).

Any information described above in connection with data 112, and any other suitable information, may be stored in memory 116.

The invention may be described in the context of computer-executable instructions, such as applications 120, being executed by a computer. Generally, programs include routines, programs, objects, components, data structures, etc., that perform particular tasks or implement particular data types. The invention may also be practiced in distributed computing environments where tasks are performed by remote processing devices that are linked through a communications network. In a distributed computing environment, programs may be located in both local and remote computer storage media including memory storage devices. It should be noted that such programs may be considered, for the purposes of this application, as engines with respect to the performance of the particular tasks to which the programs are assigned.

Computer 102 and/or terminals 130 and 132 may also include various other components, such as a battery, speaker, and/or antennas (not shown). Components of computer system 102 may be linked by a system bus, wirelessly or by other suitable interconnections. Components of computer system 102 may be present on one or more circuit boards. In some embodiments, the components may be integrated into a single chip. The chip may be silicon-based.

Terminal 130 and/or terminal 132 may be portable devices such as a laptop, cell phone, tablet, smartphone, or any other computing system for receiving, storing, transmitting and/or displaying relevant information. Terminal 130 and/or terminal 132 may be one or more user devices. Terminals 130 and 132 may be identical to system 100 or different. The differences may be related to hardware components and/or software components.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, cloud-based systems, programmable consumer electronics, network PCs, minicomputers, mainframe computers, distributed computing environments that include any of the above systems or devices, and the like.

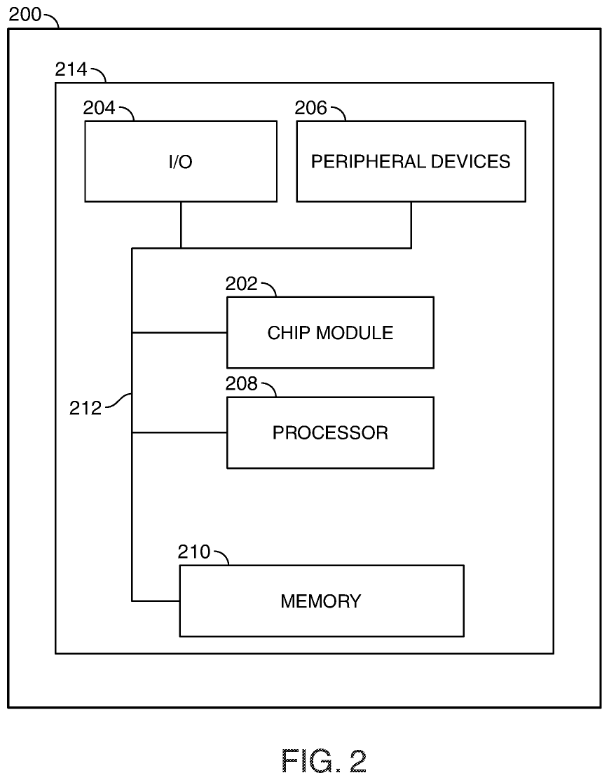

FIG. 2 shows illustrative apparatus 200 that may be configured in accordance with the principles of the disclosure. Apparatus 200 may be a computing device. Apparatus 200 may include one or more features of the apparatus shown in FIG. 1. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions, (which may be alternatively referred to herein as “computer instructions” or “computer code”), applications such as applications 120, signals, and/or any other suitable information or data structures.

Components 202, 204, 206, 208 and 210 may be coupled together by a system bus or other interconnections 212 and may be present on one or more circuit boards such as circuit board 214. In some embodiments, the components may be integrated into a single chip. The chip may be silicon-based.

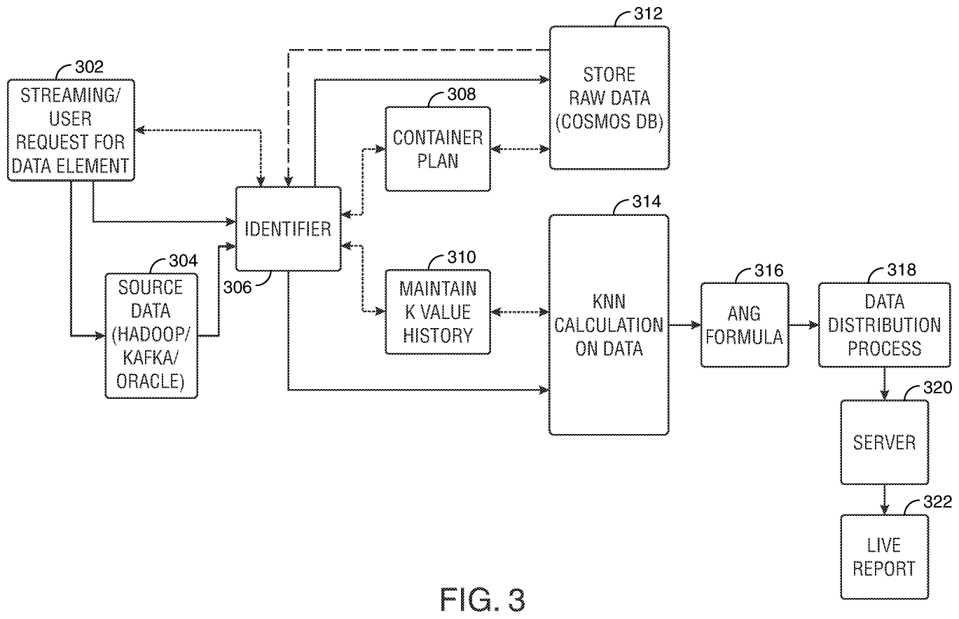

FIG. 3 shows an illustrative diagram. A user may request streaming of a data element, as shown at 302. The data element may be an application, application file, application folder, or any other suitable data element. The location in which the data element is currently located may be referred to as source data, as shown at 304, as well as source location and source data location. The streaming request may indicate the source location. The source data or source location may be Hadoop®, Kafka®, Oracle® or any other suitable source data or source location. The source location may also be a streaming location. A streaming location is a location where data is streamed.

It should be appreciated that a data element may be dynamic at a source location. As such, the data element may be continuously updated at the source location. Therefore, it may be desirable that the data being streamed to an end user may be current data. In some embodiments, current data may be understood to mean data that have been stored in a source location within a predetermined time period, such as twenty-four hours.

The streaming request may also indicate a location to which the data element should be streamed. The location to which the data element should be streamed may be referred to as an end location.

There may be an apparatus or module that receives and directs streaming requests from an organization. The apparatus or module may retrieve the data from the source locations and direct the retrieved data to the location which is specified by the user in the request.

The apparatus or module may include various components. A first component may include identifier component 306. The user request may be received at identifier component 306. Identifier component 306 may establish a communication line with source data 304. The communication line between source data 304 and identifier component 306 may be instantiated in the event that the identifier component is not able to access the data at a location internal to the apparatus. Typically, data is available after streaming within the apparatus for twenty-four hours or any other suitable time period after the data has been streamed.

In the event that the data has not yet been streamed, the data element is retrieved from a source location, such as 304, and sent to a schema-agnostic, horizontally scalable database, such as a Cosmos DB®, shown at 312. Container plan 308 may be a communicator between Cosmos DB® and identifier component 308. Container plan 308 may identify which data has been stored at Cosmos DB®. Container plan 308 may serve as an index for the data stored in Cosmos DB®.

Contemporaneously with the transmission of the retrieved data element to Cosmos DB®, the retrieved data element may also be transmitted to KNN calculation on data, shown at 314. KNN calculation on data may execute a K-nearest neighbor algorithm on the data element. The KNN calculation may identify a K-value for the retrieved data element. The K-value may be used to identify the data element. The K-values may be stored in K-value index, such the K-value history shown at 310.

The retrieved data element may be assigned an application number by an application number generator, or ANG, shown at 316.

Data distribution process 318 may distribute the data element to a server, such as server 320, based on the application number. As such, the number may be used to select a server included in a group of servers. Each server may be assigned a predetermined group of numbers. A server may be selected because it is assigned to the predetermined group of numbers that includes the application number. A live stream of the data element from server 320 to an end location may be shown at 322.

It should be noted that, in the event that the requested data element has been removed from server 320 and is still stored at Cosmos DB® 312, identifier 306 may retrieve the data from Cosmos DB® 312. Identifier 306 may forward the data element to KNN calculation 314, ANG 316, data distribution 318 and server 320 for streaming. It should be further noted that container plan 308 and K-value history 310 may be an information source for identifier 306. As such, container plan 308 and K-value history 310 may update identifier 306 as to which data elements are stored in Cosmos DB® 312 and as to which data elements are stored in server 320.

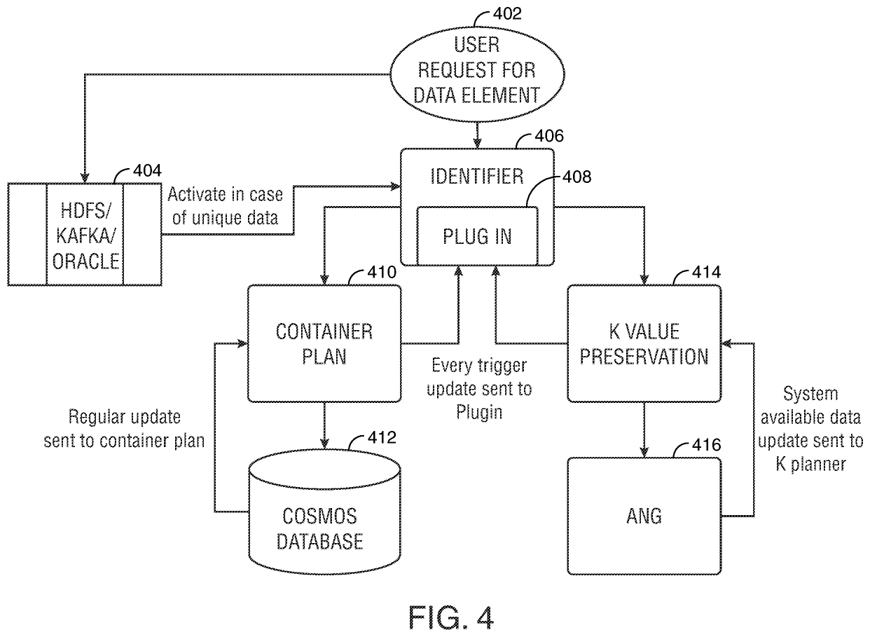

FIG. 4 shows an illustrative diagram. A user may request streaming of a data element. The user request for streaming of the data element may be shown at 402. The request may be received at identifier 406. In some embodiments, the request may also be received a source location 404. Source location 404 may be one or more data sources, such as Hadoop File System (HDFS)®, Kafka®, Oracle®, etc.

Plug in 408 may reside within identifier 406. Plug in 408 may receive updates regarding the contents of both Cosmos Database® 412 and a server (not shown) in communication with ANG 416.

Container plan 410 may receive requests for data from identifier 406. Container plan 410 may continuously receive updates from Cosmos Database® 412. As such, container plan 410 may respond to the request for data. The response to the request for data may include the data itself, the location of the data within Cosmos Database® 412 and/or information that the data is not currently stored at Cosmos Database® 412.

K-value preservation 414 may also receive requests for data from identifier 406. K-value preservation 414 may continuously receive updates from the server via ANG 416. K-value preservation 414 may respond to the request for data. The response to the request may include the data itself, the location of the data within the server and/or information that the data is not currently stored at the server.

Identifier 406 may activate a communication with a source location, such as 404. Such a communication may be activated in the event that the data is not available at either Cosmos Database® 412 or the server.

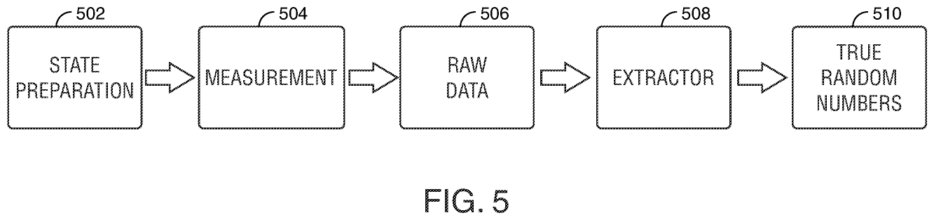

FIG. 5 shows an illustrative diagram. The illustrative diagram shows an application number generator. An illustrative application number generator may include five steps.

A first step, shown at 502, may include state preparation. State preparation may include the following: The basic setup unit of ANG is qubit (Quantum bit). A qubit exists in either a zero or one state, which is similar to a binary digit. However, qubit's state may be more than a binary state because a qubit can also be in a zero state and one state at the same time. The condition of being in zero state and a one state at the same time may be referred to as superposition. In one example, to create an application number generator, a quantum circuit containing five qubits may be created. The following code shows creating a quantum register with five qubits in a Python® computing language. As such, a qubit may be assigned as followed qr=QuantumRegister(5).

A second step, shown at 504 may include measuring the qubits in superposition states. In a perfect physical environment, such as an environment without quantum noise, with at least a predetermined number of measurements, the qubits may be able to generate a fifty-fifty distribution of zero and one quantum states. In Python® computing language, a measurement setup can be executed using the following code: circuit.measure(qr).

A third step, shown at 506, may include generation of raw data. The raw data may be generated from a practical ANG using a short random seed. The short random seed may apply an extra source of randomness. Raw data may be similar to classical randomness because of classical noises. The following includes exemplary raw data: ‘10011’, ‘00000’, ‘11100’, ‘11010’ and ‘11001’.

A fourth step, shown at 508, may include a randomness extractor. Randomness extractors may be used for distilling the true randomness and eliminating the effect of classical noises. The goal of randomness extractors may be to extract perfect randomness from the raw data. The key input parameter of a randomness extractor is the min-entropy (probability) of raw data. After the extraction the output may include the following: ‘10011’:286, ‘00000’:249, ‘11100’:285, ‘11010’:266 and ‘11010’:256.

A fifth step, or final product may be shown at 510. The final product may include true random numbers. The output of extractor may produce numbers with a high source of entropy using unique properties of quantum physics.

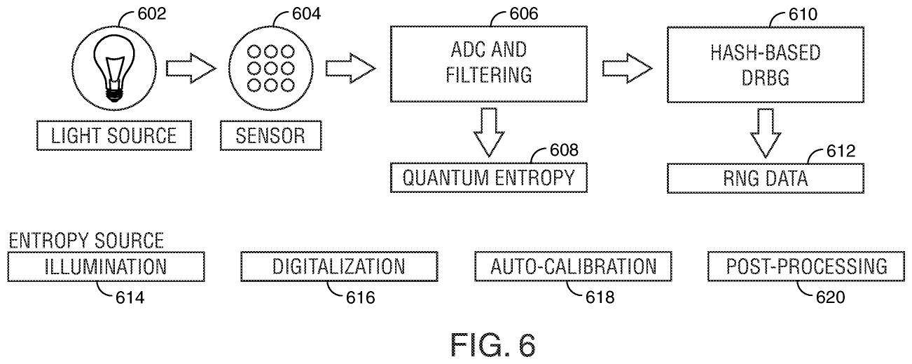

FIG. 6 shows an illustrative diagram. The illustrative diagram illustrates various components of an application number generator. An application number generator may not rely on mathematical algorithms but rather on quantum physics to generate numbers. A laser-based quantum source, such as light source 602, may generate randomness in an application number generator.

A qubit can be prepared in the superposition state (zero and one). A measurement aiming at determining whether the system is in the classical state zero or the classical state one may produce a random outcome. According to quantum physics the measurement may be inherently random. As such, the state could not have been known or predicted, independent of the amount of information or computational power available. Furthermore, the result may be perfectly unbiased.

The following may show how an entropy source, such as light, can produce a true number. This algorithm may be a part of security and trust in cryptographic systems.

The following may describe the entropy source illumination, shown at 614. Application number generation may use light. Each light may include a light-emitting diode (LED). Each LED may randomly emit photons.

The illumination element of the process may include the LED producing photons. The illumination element may also include a transmission element. The transmission element may be the location of the execution of the randomness generation process. The illumination element may also include two single-photon detectors to record the outcomes. Single-photo detectors may be detectors with single-photon resolution.

The following may describe digitalization, shown at 616. The results of the single-photon detectors may be captured on a complementary metal oxide semiconductor (CMOS) image sensor, such as sensor 604. CMOS image sensors may power a significant number of digits.

The following may describe auto-calibration, shown at 618. An analog to digital converter (ADC) and filter, shown at 606, may receive analog readings from the CMOS sensor. The ADC and filter, shown at 606, may filter the analog readings to remove noise. The ADC and filter, shown at 606, may also convert the analog readings into a digital representation of truly randomly-generated zeros and ones, which may be classified as a random string of zeroes and ones with quantum entropy, shown at 608.

The following may describe post-processing, shown at 620. The random bits can be sent directly to, and used by, a requesting application. The random bits can also be sent to one or more Deterministic Random Bit Generators (“DRNG”), shown at 610. The random number generated data (RNG data) may be shown at 612.

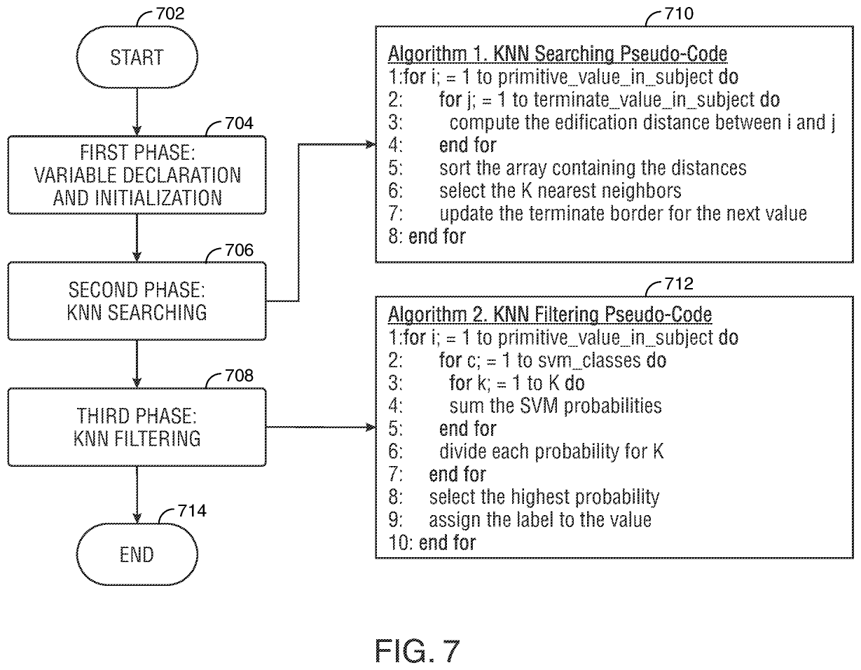

FIG. 7 shows an illustrative flow chart. The illustrative flow chart may execute a KNN calculation for an unclassified data point.

Step 702 shows a start indicator. Step 704 shows a first phase. The first phase may include variable declaration and initialization. Step 706 shows a second phase. The second phase may include KNN searching. Algorithm 1, shown at 710, shows pseudo-code for KNN searching. Algorithm 1 shows identifying the size of the circle of neighbors for the unclassified data point. The size of the circle of neighbors may be referred to as a K-value.

Step 708 shows a third phase. The third phase may include KNN filtering. Algorithm 2, shown at 712, shows pseudo-code for KNN filtering. KNN filtering includes determining the classification majority of the circle of neighbors. The result of the KNN filtering may be the classification label to assign to the unclassified data point.

It should be appreciated that unclassified data elements, received from a source location, may be processed using a KNN algorithm. Execution of a KNN algorithm may increase the uniqueness of the data within the system and lower the rate of data replication.

KNN algorithms may be a regression-type algorithm. Regression algorithms may solve a problem in which a target holds continuous values or real values. Most regression algorithms have a real number as the output. In an example, a chart can be used to estimate weight of a predefined object given its height.

A KNN algorithm may build upon regression. The KNN algorithm may include identifying a data set, where each data point in the data set is classified. The KNN algorithm may involve adding an unclassified data point to the data set. The KNN algorithm may classify the unclassified data point based on one or more attributes of the unclassified data point. The unclassified data point may be classified by a neighborly vote, where the class of close neighbors is selected.

The following steps illustrate execution of a KNN algorithm:
1. Take a dataset with known categories: In this initial step, collect unsorted, raw data.
2. Cluster the data: Cluster the data based on one or more attributes.
3. Represent a category: Add a cell to indicate an unclassified data element.
4. Find the “K-value”: In one example, finding the K-value may involve the following algorithm. The number eight may signify the total amount of data points. In an example that has eight data points, the calculation may be: √(n)=>√(8)=>2.82=>≈3.
5. Locate the “k” nearest neighbors: Locate the values that are most similar to the known attribute and identify the unknown attribute. The number of values located may be defined by the K-value. In the above example, the number of values located may be 3.
6. Classify the new point based on the majority vote of the data set: It should be appreciated that the k-value may continuously change based on a classification by a majority vote of the data set.

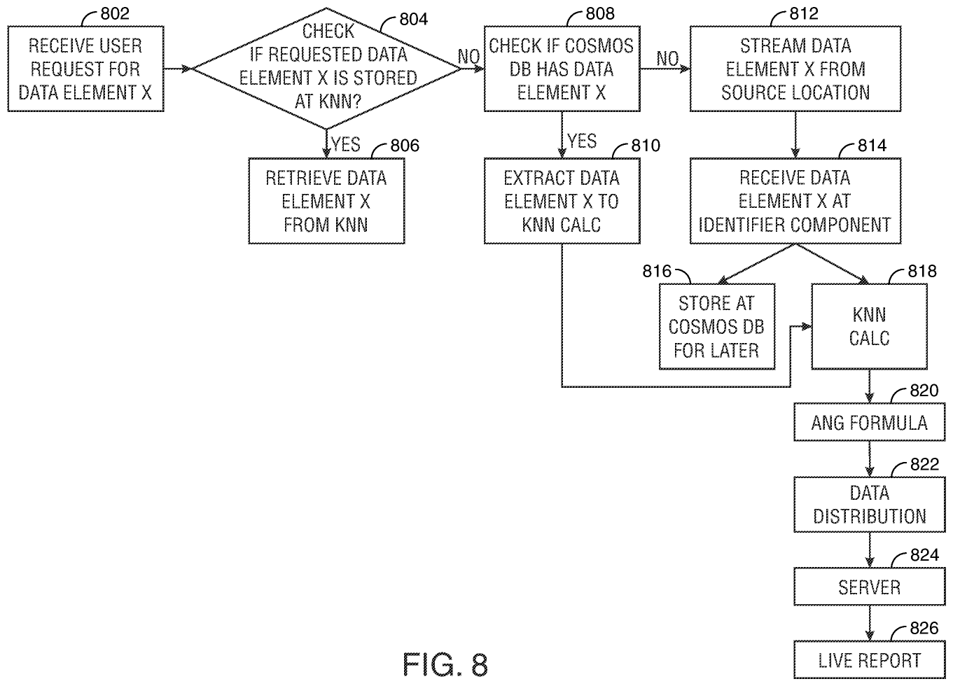

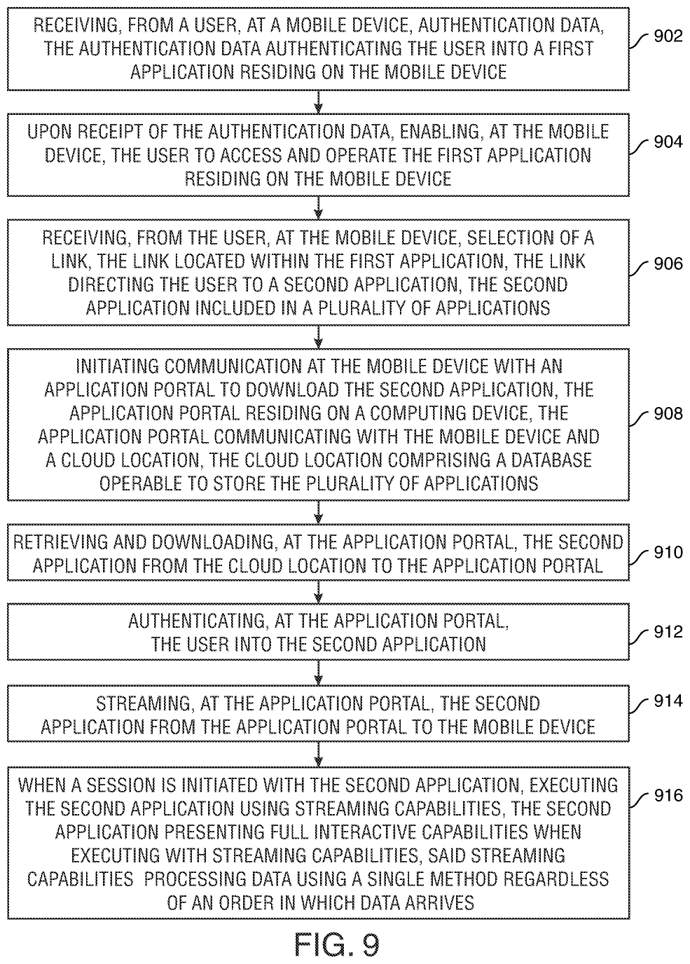

FIG. 8 shows an illustrative flow chart. Step 802 shows receipt of a user request. The user request may be to stream data element X. Query 804 shows checking if the requested data is stored at KNN. Stored at KNN may also be understood to mean, stored at a server in direct, or indirect, communication with KNN. If the requested data is stored at KNN, data element X may be retrieved from KNN, as shown at 806. If the requested data is not available at KNN, the system may check if Cosmos DB® has data element X, as shown at 808.

If data element X is not available at Cosmos DB®, data element X may be streamed from the source location, as shown at 812. Data element X may be received at an identifier component within a streaming system, as shown at 814. The identifier component may store data element X at Cosmos DB® for future retrieval, as shown at 816. The identifier component may also forward data element X to KNN calculation, as shown at 818.

KNN calculation may identify a K-value for data element X. KNN calculation may forward data element X to ANG formula, shown at 820. In the event that Cosmos DB® stores data element X, data element X may be extracted from Cosmos DB® to KNN calculation, as shown at 810.

ANG formula 820 may generate an application number for data element X. Data distribution 822 may distribute data element X to a server, shown at 824, based on the number. A live streaming of data element X, shown at 826, may be executed from the server.

Thus, an intelligent, dynamic, secure, real-time, symmetrical data streaming apparatus leveraging an application portal is provided. Persons skilled in the art will appreciate that the present invention can be practiced by other than the described embodiments, which are presented for purposes of illustration rather than of limitation. The present invention is limited only by the claims that follow.

1-20. (canceled)

21. A system comprising:
a mobile device;
a cloud location, the cloud location comprising a database operable to store a plurality of applications;
an application portal, the application portal residing on a computing device, the application portal communicating with the mobile device and the cloud location; wherein:
the mobile device receives authentication data, from a user, the authentication data authenticating the user into a first application residing on the mobile device;
upon receipt of the authentication data, the mobile device, enables the user to access and operate the first application residing on the mobile device;
the mobile device receives, from the user, selection of a link, the link located within the first application, the link directing the user to a second application, the second application included in the plurality of applications;
the mobile device initiates communication with the application portal to download the second application;
the application portal retrieves and downloads the second application from the cloud location to the application portal;
the application portal authenticates, at the application portal, the user into the second application;
the application portal streams the second application from the application portal to the mobile device; and
when a session is initiated with the second application, the second application operates using streaming capabilities, the second application presents full interactive capabilities when operating with streaming capabilities, said streaming capabilities processing data using a single method regardless of an order in which data arrives.

22. The system of claim 21 wherein the application portal utilizes a speed of 5G or faster to stream the second application to the mobile device.

23. The system of claim 21 wherein the application portal operates without downloading applications from the cloud location to the mobile device.

24. The system of claim 21 wherein the application portal operates without storing applications on the mobile device.

25. The system of claim 21 wherein the application portal streams the second application when a file size of the second application is greater than a predetermined file size.

26. The system of claim 21 wherein the application portal forms a bridge between the plurality of applications.

27. The system of claim 21 wherein applications, included in the plurality of applications, are linked to one another.

28. A method comprising:
receiving, from a user, at a mobile device, authentication data, the authentication data authenticating the user into a first application residing on the mobile device;
upon receipt of the authentication data, enabling, at the mobile device, the user to access and operate the first application residing on the mobile device;
receiving, from the user, at the mobile device, selection of a link, the link located within the first application, the link directing the user to a second application, the second application included in a plurality of applications;
initiating communication at the mobile device with an application portal to download the second application, the application portal residing on a computing device, the application portal communicating with the mobile device and a cloud location, the cloud location comprising a database operable to store the plurality of applications;
retrieving and downloading, at the application portal, the second application from the cloud location to the application portal;
authenticating, at the application portal, the user into the second application;
streaming, at the application portal, the second application from the application portal to the mobile device; and
when a session is initiated with the second application, executing the second application using streaming capabilities, the second application presenting full interactive capabilities when executing with streaming capabilities, said streaming capabilities processing data using a single method regardless of an order in which data arrives.

29. The method of claim 28 wherein the streaming the second application to the mobile device utilizes a speed of 5G or faster.

30. The method of claim 28 wherein the application portal operates without downloading applications from the cloud location to the mobile device.

31. The method of claim 28 wherein the application portal operates without storing applications on the mobile device.

32. The method of claim 28 wherein the application portal streams the second application when a file size of the second application is greater than a predetermined file size.

33. The method of claim 28 wherein the application portal forms a bridge between the plurality of applications.

34. The method of claim 28 wherein applications, included in the plurality of applications, are linked to one another.
